(19) United States
(12) Patent Application Publication
(10) Pub. No.: US 2008/0258071 A1
(43) Pub. Date: Oct. 23, 2008

(54) Standoff detection using coherent backscattered spectroscopy

(76) Inventors: Bradley R. Arnold, Columbia, MD (US); Lisa Kelly, Ellicott City, MD (US); Dustin Levy, Danbury, CT (US); Alexander Schill, Santa Clara, CA (US)

Correspondence Address: Benjamin Aaron Adler;ADLER & ASSOCIATES, 8011 Candle Lane, Houston, TX, 77071, US

(21) Appl. No.: 11/906,436

(22) Filed: Oct. 2, 2007

Related U.S. Application Data
(60) Provisional application No. 60/848,744, filed on Oct. 2, 2006.

(51) Int. Cl. G01J 1/42

(52) U.S. Cl. 250/373

(57) ABSTRACT

Provided herein are methods for detecting vapor-phase materials and/or photofragments thereof including energetic materials and decomposition products thereof, molecules or analytes at a stand-off distance. The methods provide for the stimulation of the ground state vapor phase to an excited state using a high fluence temporally and spatially focused ultraviolet laser pulse. The detection of back-scattered amplified spontaneous emission from the excited state vapor-phase material indicates the presence of the vapor phase materials.

### CROSS-REFERENCE TO RELATED APPLICATION

This nonprovisional application claims benefit of provisional U.S. Ser. No. 60/848,744, filed Oct. 2, 2006, now abandoned.

### FEDERAL FUNDING LEGEND

This invention was produced in part using funds obtained through the Office of Naval Research Grant No. N00014-05-1-0856. Consequently, the federal government has certain rights in this invention.

### BACKGROUND OF THE INVENTION

1. Field of the Invention

The present invention relates to the fields of laser-based spectroscopy and detection of explosive or energetic materials. Specifically, the present invention relates to the laser-based standoff detection of backscattered emission from energetic materials.

2. Description of the Related Art

The standoff detection of energetic materials has been an important and challenging problem to researchers for a number of years. Recent advances in laser technology have seen the increased application of laser spectroscopy to the problem of energetic material detection, but a robust solution has yet to be elucidated. The applications of THz wave, LIBS and UV-LIF/REMPI spectroscopy have been considered in a number of studies.

Recently, THz waves generated by femtosecond laser pulses in p-type InAs were used to obtain reflectance spectra of cyclotrimethylenetrinitramine (RDX) after propagation of the THz wave over a distance of 30 m [1-2]. Broadband terahertz emission from laser induced plasma in air using focused femtosecond laser pulses was recently reported and has potential application to standoff detection in the THz frequency range [3]. Coherent control and detection of THz waves generated through a four-wave mixing process in laser guided filaments [4] and the detection of such waves in air [5] is an application of ultrashort laser pulse technology, but the measurements are difficult and require controlled experimental conditions and expensive laser systems for operation.

Laser induced breakdown spectroscopy (LIBS) has shown potential to be an analytical tool due to its simplicity and demonstrated performance in both point detection and standoff applications. Laser induced breakdown spectroscopy has been applied to the detection of chlorine and fluorine [6], halogenated hydrocarbons [7], lead [8], bacterial spores and molds [9], molten metals [10-11], and polycyclic aromatic hydrocarbons [1,2]. Numerous studies have focused on the detection of hazardous materials such as chemical and biological agents [1,3] and landmines [14-15], with recent demonstrations of standoff detection of the materials [16-17] at ranges up to 30 meters. However, the application of LIBS involves the use of high energy laser operation in wavelength bands that are particularly dangerous to the eye (400-1100 nm) and such instruments would not be suitable for eye-safe operation in the field for stand-off detection of energetic or other hazardous materials.

The application of ultraviolet (UV) laser induced fluorescence (LIF) and resonance-enhanced multiphoton ionization (REMPI) to the detection of energetic materials, particularly nitro-substituted compounds, has seen success in terms of sensitivity, selectivity and limits of detection. Vapor phase nitro compounds can readily fragmented with ultraviolet radiation due to the weak bond energy of the nitro functional group (40-50 kcal/mol), resulting in free NO₂ and NO which are detected using REMPI, PI or LIF. Using ˜226 nm laser pulses to fragment and subsequently ionize the photofragments, detection limits of 8 and 24 ppb of RDX and TNT respectively were reported using REMPI [18]. A simpler method employing photoionization (PI) spectrometry following the photofragmentation process gave similar performance in detection limits with the application of low (eye-safe) UV pulse energies (10 μJ/pulse) [19].

While ionization methods can particularly sensitive for detection of photofragments, the requirements of ultra-high vacuum-sealed sample chambers makes them inapplicable to standoff detection of energetic materials. Similar sensitivities to those achieved through photofragmentation with REMPI and PI can obtained using laser-induced fluorescence (LIF). Following pre-dissociation of NO₂ by laser photolysis of nitro compounds, NO can be excited near 226 nm and LIF from the excited NO fragment can be detected. Detection limits of 40 ppb for TNT imbedded in soil samples can be achieved using this technique in a point detection application [20].

The advantage of using all-optical methods of detection is the potential to employ coherent laser stimulated processes to enhance the intensity and directionality of the emitted signals from UV generated excited states or photofragments. Combined with the fact that UV lasers are rated eye-safe up to several millijoules per pulse, the use of UV excitation for standoff detection of energetic materials is a feasible option. Stimulated processes have been observed since the invention of the laser. Some of the earliest observations included stimulated Raman scattering from organic liquids and vapors. Stimulated Raman scattering from benzene, nitrobenzene, toluene, 1-bromonapthalene, pyridine, cyclohexane, and deuterated benzene was first characterized using a Q-switched ruby laser [21].

Early studies also noted the existence of both forward and backward stimulated Raman scattering [22]. Backscattered emission is particularly applicable to standoff detection methodologies in which the signal generated at a distance returns to the detection platform. Backward-stimulated Raman pulses from CS₂ liquid were characterized in terms of pulse energy, pulsewidth and linewidth [22]. It was found that the Raman pulses emitted in the backward direction had different pulse characteristics than those emitted forward. The development of picosecond laser pulses contributed to increased stimulated Raman generation with milder pulse energies and the observation of stimulated Raman pulses in gaseous hydrogen, deuterium and methane [23].

There remains a recognized need in the art for vapor-phase detection capabilities of these and other materials. Specifically, the prior art is deficient in systems and methods for a real-time laser-based stand-off detection of coherent backscattered emissions from the vapor phase. The present invention fulfills this long-standing need in the art.

### SUMMARY OF THE INVENTION

The present invention is directed to a method for detecting the presence of a vapor-phase analyte at a distance. The method comprises selecting a wavelength absorbed by an analyte of interest and generating a laser pulse of the selected wavelength by a laser source. The vapor-phase molecules of the analyte are stimulated from a ground state to an excited state within a cylindrical volume via the laser pulse at a defined distance from the laser source and the coherent backscattered amplified spontaneous emission (BASE) from the excited state molecules within the cylindrical volume is detected thereby detecting the presence of the vapor-phase analyte. The present invention is directed to a related method comprising a further step of stimulating a photoproduct of the excited state molecules within the cyclindrical volume with another laser pulse after stimulating the vapor phase molecules. The present invention is directed to another related method comprising a further step of ablating or thermally desorbing the analyte from a solid surface prior to selecting the absorbed wavelength. The present invention is directed to yet another related method comprising a further step of creating a spectral fingerprint from the detected BASE.

The present invention also is directed to method for real-time stand-off detection of an energetic material. The method comprises temporally focusing a high fluence ultraviolet laser pulse on a site of interest at a stand-off distance from a laser source and stimulating vapor-phase molecules associated with the energetic material to an excited state within a cylindrical volume at the site of interest via the laser pulse. The coherent backscattered amplified spontaneous emission (BASE) from the excited state molecules within the cylindrical volume is detected and the vapor-phase molecule from the BASE is identified upon the detection thereof, thereby detecting the energetic material at a stand-off distance in real-time. The present invention is directed to a related method comprising a further step of stimulating a photoproduct of the excited state molecules within the cyclindrical volume with another high fluence ultraviolet laser pulse after stimulating the vapor-phase molecules.

Other and further aspects, features and advantages of the present invention will be apparent from the following description for the presently preferred embodiments of the invention. These embodiments are given for the purpose of disclosure

### BRIEF DESCRIPTION OF THE DRAWINGS

So that the matter in which the above-recited features, advantages and objects of the invention as well as other which will become clear are attained and can be understood in detail, more particular descriptions and certain embodiments of the invention briefly summarized above are illustrated in the appended drawings. These drawings form a part of the specification. It is to be noted, however, that the appended drawings illustrate preferred embodiments of the invention and therefore are not to be considered limiting in their scope.

FIG. 1A illustrates that high peak power laser pulse produces high concentration of “excited states” within the interaction volume. FIG. 1B illustrates that spontaneous emission from excited states occurs with random probability distribution. FIG. 1C illustrates that spontaneous emission directed perpendicular to the excitation axis leaves the sample while emission directed parallel to the excitation axis has a high probability of encountering additional excited states and causing stimulated emission. FIG. 1D illustrates that the backscattered signal returns to the detection platform as an intense coherent pulse.

FIG. 2 depicts ground state absorption spectra of target organic vapors at room temperature.

FIG. 3 depicts absorption (open squares) and laser induced luminescence (closed circles) spectra of acetone vapor at room temperature. Laser induced luminescence collected using 40 mJ, 266 nm Q-Switched Nd:YAG laser pulses.

FIG. 4A depicts a profile of the backscattered laser induced luminescence from naphthalene vapor at room temperature. Pump laser characteristics: 40 mJ, 266 nm, 2 mm beam waist. FIG. 4B is a representation of the effective minimum path-lengths of excited states produced by pump lasers with the different pulse widths used in this study.

FIG. 5 depicts backscattered laser induced luminescence from benzene, toluene and naphthalene vapors (˜10⁻³ torr in N₂) collected using 40 mJ, 8 ns, 266 nm laser pulses from a stand-off distance of 15 m.

FIG. 6 depicts backscattered laser-induced fluorescence from o-nitrotoluene vapor (˜10⁻³ torr in N₂) collected using a 1 mJ, 8 ns, 213 nm laser pulse at a standoff distance of 3 m.

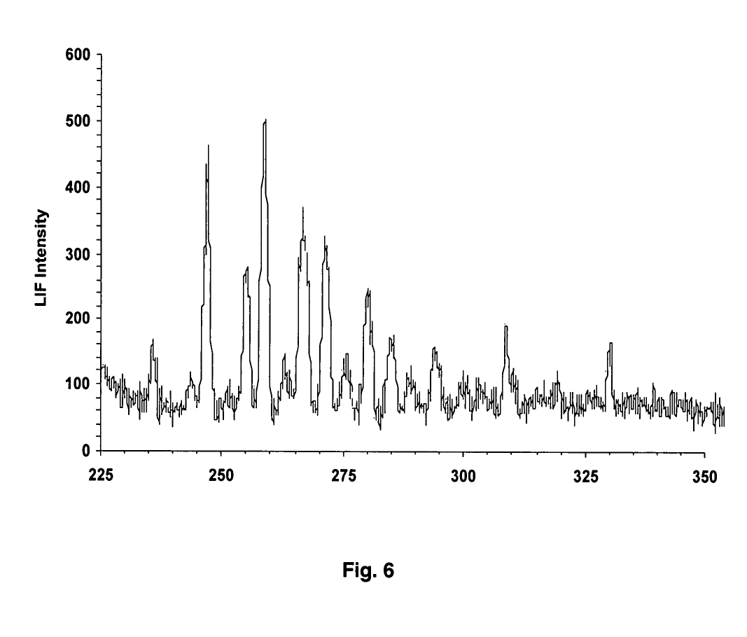

### DETAILED DESCRIPTION OF THE INVENTION

As used herein, the term “a” or “an”, when used in conjunction with the term “comprising” in the claims and/or the specification, may refer to “one”, but it is also consistent with the meaning of “one or more”, “at least one”, and “one or more than one”. Some embodiments of the invention may consist of or consist essentially of one or more elements, method steps, and/or methods of the invention. It is contemplated that any device or method described herein can be implemented with respect to any other device or method described herein. As used herein, the term “or” in the claims refers to “and/or” unless explicitly indicated to refer to alternatives only or the alternatives are mutually exclusive, although the disclosure supports a definition that refers to only alternatives and “and/or”. As used herein, the term “BASE” refers to Backscattered Amplified Spontaneous Emission.

In one embodiment of the present invention there is provided a method for detecting the presence of a vapor-phase analyte at a distance, comprising (a) selecting a wavelength absorbed by an analyte of interest; (b) generating from a laser source a laser pulse of the selected ultraviolet wavelength; (c) stimulating vapor-phase molecules of the analyte from a ground state to an excited state within a cylindrical volume via the laser pulse at a defined distance from the laser source; and d) detecting coherent backscattered amplified spontaneous emission (BASE) from the excited state molecules within the cylindrical volume thereby detecting the presence of the vapor-phase analyte.

Further to this embodiment the method comprises stimulating a photoproduct of the excited state molecules within the cyclindrical volume with another laser pulse after step (c). Particularly, this laser pulse may have a different wavelength. In another further embodiment the method also comprises ablating or thermally desorbing the analyte from a solid surface prior to selecting the absorbed wavelength. In yet another further embodiment the method comprises creating a spectral fingerprint from the detected BASE.

In all embodiments of the present invention the selected wavelength may be an ultraviolet wavelength. Alternatively, the selected wavelength may be a spontaneously generated harmonic ultraviolet wavelength. Particularly, the selected ultraviolet wavelength may be generated from within a spectral range of about 213 nm to about 1200 nm. Also, in all embodiments the detection distance may be about 0.01 km to about 1 km and the laser pulse may have a pulse width of about 150 fs to about 8 ns. In addition a lower detection limit of the vapor-phase analyte may be about 1 ppm. Furthermore, the stimulated molecule may be a photofragment of the vapor-phase analyte. Further still, detection of BASE may be in real time.

Also, in all embodiments, a representative analyte may be a combustible material, a volatile solvent, a flammable solvent, a taggant, a stimulant, a gas, a gas mixture, or a solid. Representative examples of the combustible material are a TATP decomposition product, a nitro-aromatic compound, a nitroamine, or other nitro-containing compounds.

In another embodiment of the present invention there is provided a method for real-time stand-off detection of an energetic material, comprising (a) temporally focusing a high fluence ultraviolet laser pulse on a site of interest at a stand-off distance from a laser source; (b) stimulating vapor-phase molecules associated with the energetic material to an excited state within a cylindrical volume at the site of interest via the laser pulse; (c) detecting coherent backscattered amplified spontaneous emission (BASE) from the excited state molecules within the cylindrical volume; and (d) identifying the vapor-phase molecule from the BASE upon the detection thereof, thereby detecting the energetic material at a stand-off in real-time. Further to this embodiment, the method comprises stimulating a photoproduct of the excited state molecules within the cyclindrical volume with another high fluence ultraviolet laser pulse after step (b). Particularly, this laser pulse may have a different wavelength.

In these embodiments, the ultraviolet laser pulse may have a wavelength or a harmonic wavelength generated from within a spectral range of about 213 nm to about 1200 nm. Also, the stand-off distance may be about 0.01 km to about 1 km. In addition, the temporally focused laser pulse has a pulse width of about 150 fs to about 8 ns. Furthermore, the lower detection limit and the stimulated photo-fragment are as described supra.

Also in this embodiment the energetic material may be a TATP decomposition product, a nitro-aromatic compound, a nitroamine, or other nitro-containing compound. Particularly the energetic material may comprise an improvised explosive device.

Provided herein are methods using ultra-fast peak-power pulsed laser sources for standoff detection of chemical vapors of materials, such as, although not limited to, energetic materials. Intense laser pulses, for example having a wavelength in the ultraviolet range, generate coherent backscattered emission within an interaction volume by producing high concentrations of excited states of vapor phase materials or analytes contained therewithin. Stimulated or amplified spontaneous emission from a target molecule produces a minimally divergent, directional beam back to a detector. The characteristics of the backscattered beam depend largely on the intensity and pulse width of the laser source as well as the concentration and photo-physical characteristics of the target molecule.

Different target molecules exhibit different backscattered emission signals, allowing differential detection of energetic materials in the vapor phase. Different target molecules exhibit different backscattered emission signals, allowing differential detection of energetic materials in the vapor phase. Because of the highly directional nature of the coherent backscattered beam, detection limits in the vapor of less than 1 ppm at ranges of 100 meters or more are achievable. Generally, it is contemplated that detection of vapor phases of energetic materials is effective for distances of 0.01 km to about 1 km.

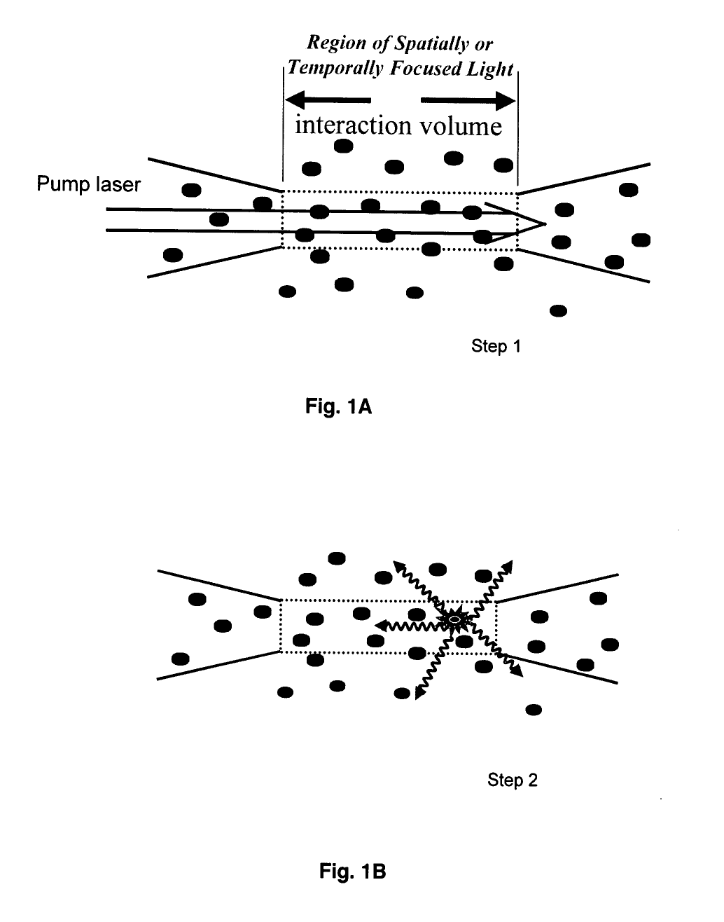

In standard BASE, a laser pulse, e.g., a pump laser pulse, is used to excite a specific volume or interaction volume of vapor phase analyte. Temporal or spacial focusing of the laser beam is useful to control the distance between the instrument and interaction volume. Focusing results in a cylindrical volume with a relatively high concentration of excited states. The long axis of the cylindrical volume is defined by the direction of pump laser pulse and the short axes are perpendicular to the pump pulse (FIG. 1A).

In some cases, the excited states emit radiation spontaneously, for example, as fluorescence, but also, as Raman scatter, LIBS, continuum generation, etc. Spontaneous processes occur randomly within the sample volume and the emitted photons leave the interaction volume in all possible directions (FIG. 1B). Spontaneous emission is characterized by noting that the probability of observing emission is in direct proportion to the excited state concentration.

Spontaneous emission that happens to leave the sample along the short axis of the interaction volume has little chance of interacting with any additional excited states. Because these are randomly directed from a point inside the sample, the probability of observing them decreases as the square of the distance of the observer/detector from the sample. Therefore, the observation of spontaneous emission is easiest close to the sample and becomes much more difficult as the distance increases.

However, if one excited state happens to emit a photon parallel to the pump axis within the interaction volume, the probability of this photon interacting with additional excited states is relatively high and stimulated emission can result. Note that the probability of emission in either direction along the pump axis is independent of the direction the pump laser pulse traveled. Both forward scattered, i.e., in the same direction as the pump pulse, and back-scattered emission, i.e., in the opposite direction as the pump pulse, have been observed. If stimulated emission does occur, its direction is not random, but is instead a second photon that is a copy of the first. This copying process results in amplification of the observed emission along the pump axis of the interaction volume (FIG. 1C).

As stimulated processes continue to occur, the emission becomes much more intense in the direction parallel to the pump axis—in both the forward and back directions. FIG. 1D shows only the back-scattered amplified spontaneous emission (BASE) pulse, but a forward amplified pulse also is expected and observed. The BASE pulse is much more intense than the spontaneous emission and it is highly directional so that it is easily observed traveling back towards the source of the initial pump beam even at large distances.

Reaction Scheme 1 depicts the steps in FIGS. 1A-1D:

Step 1 A+hν→A*(FIG. 1A)

Step 2 A A→*+hν′ (FIG. 1B)

Step 3 A*+hν′→A+2 hν′ (FIG. 1C)

Step 4 (Repeat Step 3) (FIG. 1D)

where hν is the pump laser pulse, hν′ is the fluorescence from A* and A is the ground state and A* is the excited state of the analyte.

It is contemplated that the methods provided herein are useful to detect photofragments of a parent compound. Emission from a parent compound may not be observed because the parent excited-state undergoes rapid photo-induced fragmentation, isomerizations or other photochemical transformation. The products of these reactions are generally produced in the ground state and do not fluoresce and, therefore, no spontaneous emission or BASE is present. A pulse sequence of two or more laser pulses in which there is control over the timing and wavelengths of the individual laser pulses within the sequence is utilized. The initial pulse, or synthesis pulse, can be used to convert parent compound into photoproducts. A second pulse, or probe pulse, then pumps the products into excited states within the interaction volume as shown in Scheme 1, Step 1. BASE of the products can be observed (see Example 3).

Reaction Scheme 2 demonstrates the sequence:

Step 0 A+hν→A*
A*→B

Step 1 B+hν′→B*

Step 2 B→B*+hν″

Step 3 B*+hν″→B+2 hν″

Step 4 (Repeat Step 3)

The analyte, A, is converted into a photoproduct B, which subsequently undergoes excitation and BASE. B* depicts the photoproduct excited state while hν is the synthesis laser pulse, hν′ is the pump laser pulse and hν″ is the observed emission from the photoproduct B. Therefore, it is contemplated that pulse sequences may be useful to observe BASE in parent compounds and/or photo-fragments thereof.

The laser sources useful in the systems and methods described herein may be lasers effective to generate one or more ultraviolet wavelengths or generate one or more harmonics therefrom in the ultraviolet range of the spectrum. Particularly a spectral range of about 213 nm to about 1200 nm encompasses ultraviolet wavelengths and those wavelengths from which the ultraviolet harmonic wavelengths may be generated. The generated laser pulses may have a duration or pulse width of about 140 fs to about 8 ns. For example, as is known in the art, Nd:YAG lasers or Ti:Sapphire lasers may be used. Table 1 provides a non-limiting summary of applicable laser sources.

TABLE 1

| Source | Wavelength (nm) | Pulse Width |
|---|---|---|
| Q-switched & mode- | 1064, 532, 355, | 35 ps-8 ns |
| locked Nd:YAGs | 266, 213 | |
| Mode-locked | λ_{f} = 720-850 | 50 fs |
| Ti:Sapphire | (tunable) and λ_{f}/2, λ_{f}/3 | |
| Ti:Sapphire | 300-1200 (tunable) | 150 fs |
| pumped OPA | | |
| Mode-locked | λ = 720-900 | 10-13 fs |
| Ti:Sapphire | λ_{f} = 800 | |
| Mode-locked | Tunable λ = 720-850 | 150 fs |
| Ti:Sapphire | | |
| Mode-locked | λ_{f} = 800 nm | 50 fs |
| Ti:Sapphire | | |

Generally, a system effective to generate and detect BASE pulses comprises at least one or two UV lasers, e.g., a UV pump laser effective for generating harmonic wavelengths and a means for detecting the BASE pulses, e.g., photomultiplier tube or an intensified charge coupled device (ICCD)/spectrograph system, including necessary electronic means to amplify, analyze and display the BASE spectra. The high fluence, i.e., about 1-100 mJ per pulse, of a temporally focused laser pulse leads to a refractive index change and the generation of a harmonic wavelength, preferably the third harmonic. The configuration and optics depend upon the laser source being used. As is known in the art this may include, inter alia, one or more filters, harmonic generators, one or more lenses, e.g., collimating lenses and/or focusing lenses, amplifiers, etc.

In addition, including pulse combinations and sensitive gated detection schemes in a stand-off BASE detection system is useful to lower the detection limit thereof. Furthermore, sampling methodologies may include ablation, e.g., near-infrared wavelengths, such as 1064 nm, or thermal desorption of analytes or molecules from surfaces followed by coherent backscattered laser induced fluorescence of the liberated vapors. This increases the types of detectable analytes and enhances the detection abilities of standoff BASE spectroscopy.

The methods provided herein are useful to generate a library of spectral fingerprints of materials of interest. For example, these may include fingerprints of gases, gas mixtures, volatile or flammable solvents, and solids. Stand-off detection of combustible gases also is contemplated, e.g., solvents, precursors, taggants, stimulants, and decomposition products of energetic materials. Without being limiting, representative combustible materials include TATP decomposition products, e.g., acetone, nitro-aromatics, e.g., TNT and DNT, nitramines, e.g., RDX and HMX, other nitro-compounds, e.g. PETN, taggants, and stimulants, e.g., chlorate and nitrate stimulants, or the decomposition products of these materials.

As such it is further contemplated that the methods provided herein are useful in a ruggedized, portable, stand-off detection system for explosives and related compounds. For example, and without being limiting, such a stand-off detection system has significant military applications. Vehicle borne sensor systems can scan the projected travel route of a vehicle/convoy. Information from the sensor is processed to map out the locations of energetic materials, allowing detection of emplaced improvised explosives devices (IEDs) and the assembly, storage, and transportation of IEDs. It is also contemplated that the methods provided herein are useful for probing planned routes for toxic chemicals, chemical warfare agents, and biological warfare agents. In addition, it is contemplated that stand-off detection of BASE may be adapted to include the remote monitoring of manufacturing facilities and the real-time detection of materials of interest within public facilities.

The following examples are given for the purpose of illustrating various embodiments of the invention and are not meant to limit the present invention in any fashion.

### EXAMPLE 1

### Absorption Spectroscopy of Vapors

Absorption spectra of vapor samples were collected using a sealed 5 cm path-length quartz cell containing a small droplet or a few crystals of the sample material. Vapor samples for laser experiments were generated by bubbling dry nitrogen gas through pure liquids or over solid crystals of the materials of interest. Benzene, toluene and acetone spectroscopic grade solvents were purchased from Aldrich and used without further purification. Naphthalene (99%) crystals were purchased from Aldrich and used without further purification. Vapor samples were pumped into cylindrical glass tubes of different diameters and lengths, all without windows. Vapor was confined to the sample cell by the use of small vacuum inlets at the ends of the cell that were evacuated using a small laboratory vacuum pump. The outlet of the vacuum pump was directed to a custom lab ventilation system to prevent the accumulation of potentially hazardous levels of vapor in the laboratory space. Partial pressures of vapor under these sample conditions range from 10⁻³ to 1 torr, depending on the sample. Concentrations were determined by measuring the transmission at 266 nm along the sample tube in relation to the transmission of a saturated cell of vapor sample of which the vapor pressure at room temperature is known.

### Lasers

YAG laser operating at a repetition rate of 10 Hz and having an 8 ns pulse duration. Typical pulse energies for the experiment were 1-50 mJ. The beam diameter at the output of the laser was 6 mm and was focused within the sample using a 100 cm focal length fused silica lens. The UV laser pulses were launched down the center of the sample tube using a harmonic separating beam splitter. Backscattered radiation from the sample was observed through the back of the beam splitter, collinear with the pump axis of the incoming laser pulse. A beam dump at the outlet of the sample tube captured remaining pump laser radiation.

### Detection of Emission Spectra

Characterization of the backscattered vapor emission was carried out using beam profiling, luminescence spectroscopy and kinetics measurements. The emission was profiled using a CCD array equipped with a quartz camera lens. Narrow band-pass filters were used to isolate the sample luminescence from background emission from the laser. To obtain luminescence spectra the backscattered emission was collected and focused onto a fiber optic bundle and sent to the input slit of a 300 mm spectrograph. Kinetics measurements were carried out using a photomultiplier tube detector with an instrument response function of 8 ns. A narrowband interference filter was used to isolate the emission from the sample against background emission from the laser fundamental and scattered radiation from the optics.

### EXAMPLE 2

### Target Organic Vapor Ground State Absorption Spectra

Ground state absorption spectra of some target organic vapors are shown in FIG. 1. Many of the materials of interest have strong resonances in the ultraviolet which are accessible with the 4^{th} or 5^{th} harmonic of a Q-Switch Nd:YAG laser. Producing pulse energies of 10-100 mJ for the 4^{th} and 5^{th} harmonic, such sources can potentially produce high excited state densities within the interaction volume and may lead to amplified and directed luminescence from the excited state materials. Even weakly luminescent materials can be detected using these laser induced fluorescence techniques.

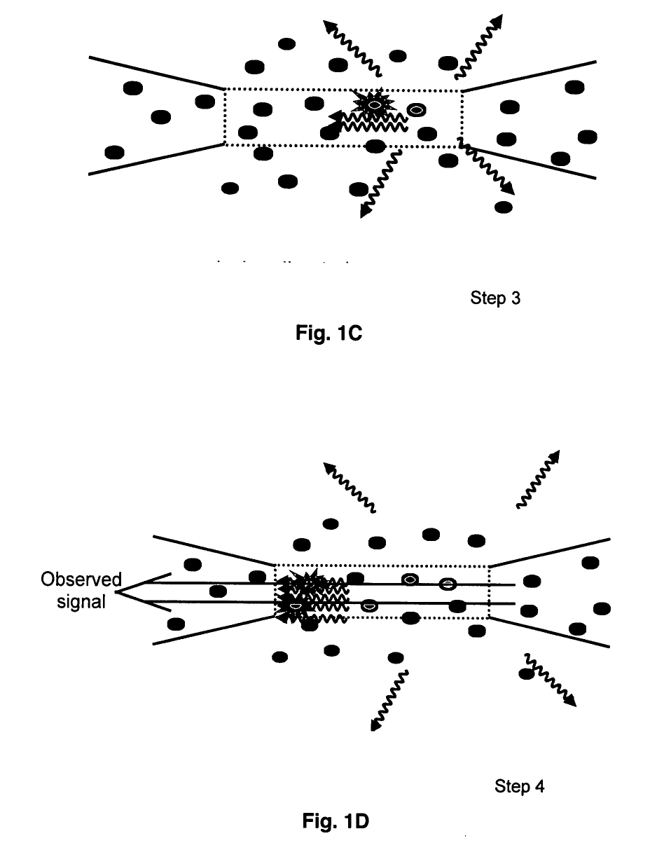

The absorption and laser-induced fluorescence spectrum of acetone vapor is shown in FIG. 2. Acetone is known to have low quantum efficiency for luminescence, reportedly owing to its very short-lived lowest excited singlet state [24-27]. However, with the excited state densities produced by intense laser excitation (˜10²⁵ m⁻³) it is possible to detect its luminescence, even without the use of intensified and gated CCD arrays.

### EXAMPLE 3

### Backscattered Luminescence as a Function of Pulse Width

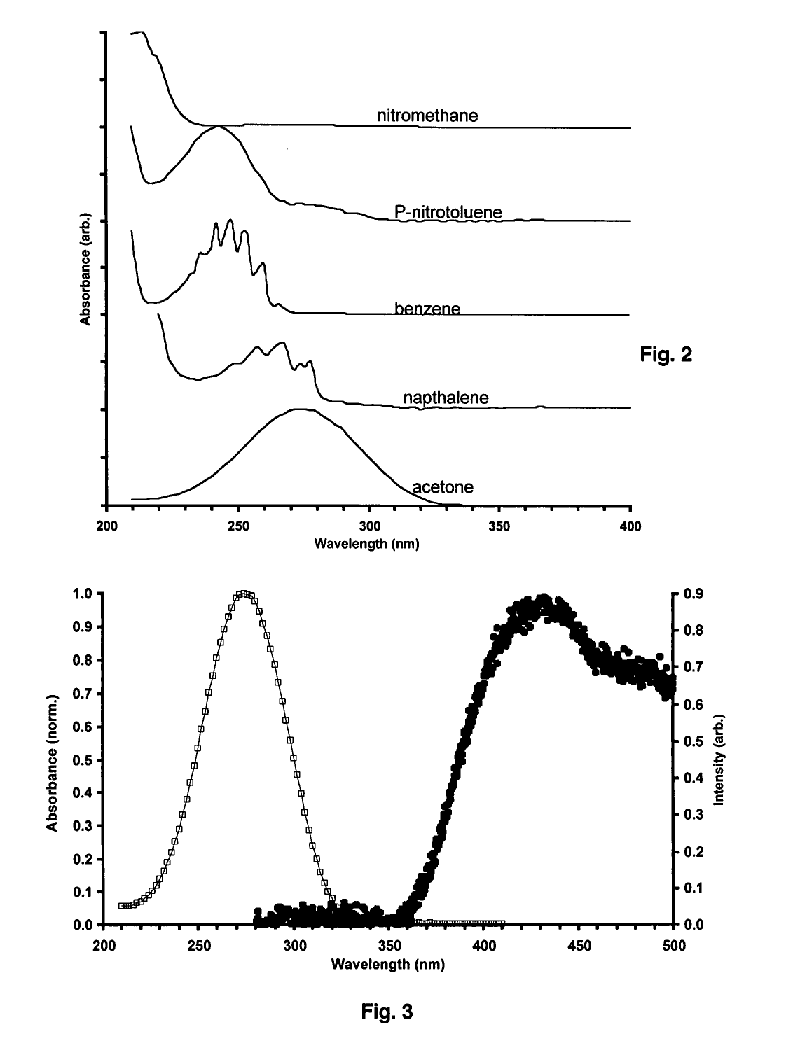

One advantage gained by using amplified luminescence for backscattered standoff detection is illustrated in FIG. 3A. The surface plot in FIG. 3A shows the backscattered luminescence profile of naphthalene vapor excited with an intense 266 nm laser pulse. A CCD camera was positioned along the pump axis to observe backscattered emission at a distance of 3 meters from the sample position. Similar measurements were taken perpendicular to the pump axis at the same range for comparison. Luminescence was filtered though a narrowband interference filter centered on the maximum of the luminescence of naphthalene. In the perpendicular detection geometry, luminescence was barely discernable above the noise, giving at most 100 counts per pixel across the entire length of the sample (dark counts±30 counts/pixel). Contrast this with the signal obtained along the pump axis shown in FIG. 3A, in which the counts are well over 1000 across the middle cross section of the backscattered image.

The advantage gained in this method is only realized using the correct pump laser pulse to generate the excited state volume. The pulse-width of the laser dictates the path-length of the excited states in the vapor, and a significant path-length is required to achieve a bright, spatially coherent image of the luminescence back at the detection platform. FIG. 3B shows the minimum effective path-length of excited states produced by different pump laser pulse-widths. Depending on the concentration, lifetime and luminescence efficiency of the sample, some laser pulses, no matter how intense, will not produce a spatially bright image of the luminescence at standoff range.

The backscattered luminescence from a number of vapor samples using UV pulses of all three pulse-widths is shown in FIG. 3B. For samples such as benzene, toluene and naphthalene, the luminescence in the backscatter geometry is intense and spatially coherent for all laser pulses utilized. Acetone vapor behaves differently, giving intense signal only with the use of 8 ns pulses from a Q-Switched Nd:YAG. The intensity from a 35 ps pulse is significantly less than that of the 8 ns and with 150 fs pulses the luminescence is not detectable. Acetone is different from the other probes in that its luminescence is “pulse-width determined” rather than “life-time determined”.

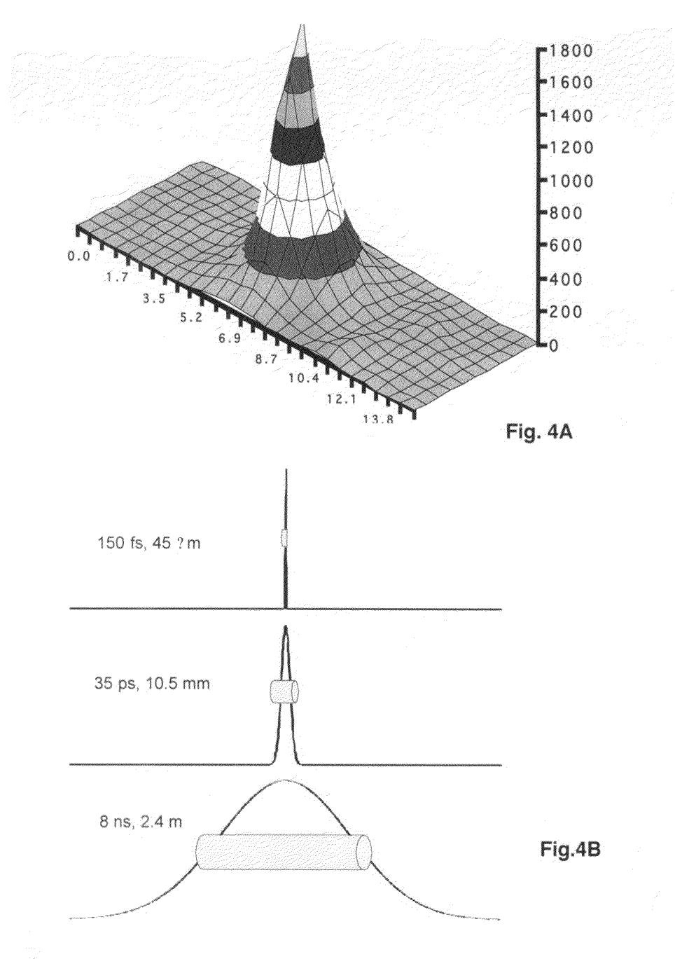

As mentioned, the first excited singlet state lifetime of acetone in the vapor phase is <150 fs, shorter than the pulse duration of the pump lasers utilized. This means that the path-length of the interaction volume for acetone vapor will be determined strictly by the laser pulse-width as illustrated in FIG. 3B, whereas the path-length for benzene, toluene and naphthalene could potentially be longer than that dictated by the laser pulse-width up to a maximum determined by the lifetime of the lowest excited singlet state. For benzene, toluene and naphthalene, the excited state lifetimes are 20-200 ns, longer than the pulse-width of the lasers used herein. The quality of the backscattered luminescence obtained for vapors of benzene, toluene and naphthalene is illustrated in FIG. 4. The spectra presented herein were collected at a distance of 15 m from the sample through a 3 mm aperture collection optic using 40 mJ, 266 nm laser pulses.

### EXAMPLE 3

### Detection of Photo-Fragment Luminescence

The importance of pulse-width is not only limited to controlling the length of the interaction volume, it can also dictate the types of processes observable and exploited for standoff detection. For energetic materials of interest, the parent molecules themselves are very weakly luminescent and it is unlikely that luminescence from the parents can be used for any reasonable detection application. However, the photo-fragments produced from these materials can luminance quite intensely.

Photo-fragmentation followed by subsequent laser-induced fluorescence of the fragments would require two consecutive UV photons of the correct energy and delayed in time enough to capture the photo-fragment after it has dissociated far enough from the reaction center to be considered a free species. With picosecond and sub-picosecond pulses, this condition cannot be met within a single pulse envelope and would require two separate pulses delayed electronically or mechanically from one another.

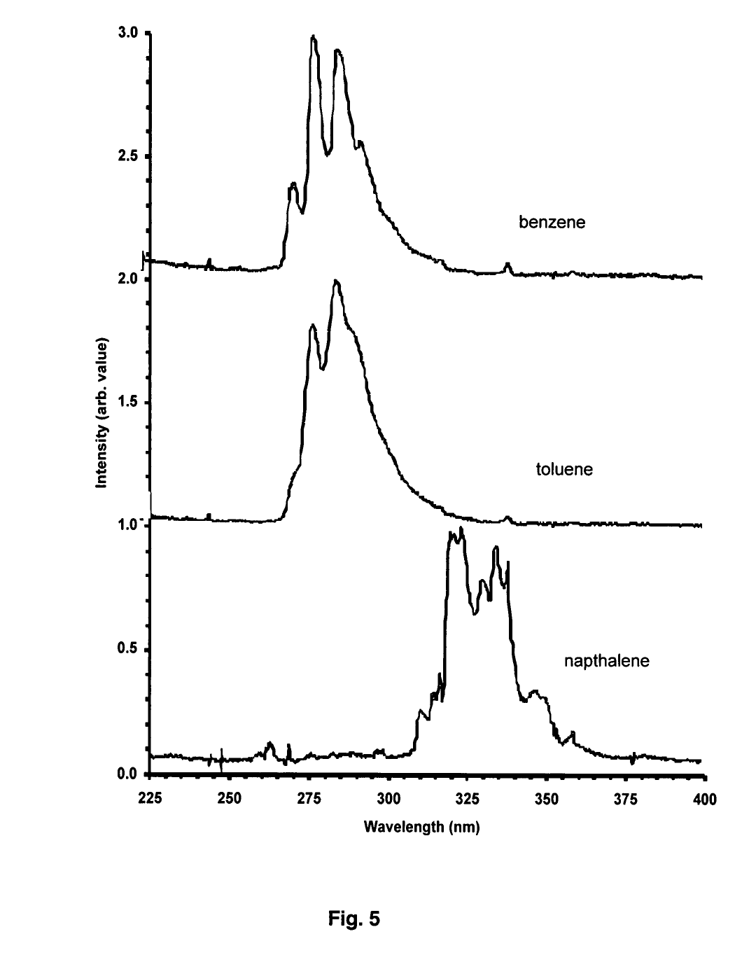

The use of an 8 ns pulse of 213 nm radiation to generate a spatially coherent image of the laser-induced fluorescence from o-nitrotoluene vapor at a range of 3 meters is shown in FIG. 5. The emission spectrum seen here consists of fluorescence from both the NO₂ and NO photo-fragments known to be present upon photo-fragmentation of nitrotoluenes at room temperature [28]. In two-color, two-photon BASE, the parent could adsorb 266 nm and photo-fragment to NO₂ and NO. A second pulse at 213 nm would yield detectable BASE from the photofragments.

The following references are cited herein.
1. Zhong et al. (2005) Standoff distance detection of explosive materials with THz waves. in 2005 13th International Conference on Terahertz Electronics.
2. Liu et al. (2006) Optics Express 14(1):415-423.
3. Zhong et al. (2006) Applied Physics Letters, 88.
4. Xie et al. (2006) Physical Review Letters, 96.
5. Dai et al. (2006) Physical Review Letters, 97.
6. Cremers, D A and Radziemski, L J (1983) Analytical Chemistry, 55:1252-1256.
7. Williamson et al. (1998) Analytical Chemistry, 70:1186-1191.
8. Wainner et al. (2001) Spectrochimica Acta Part B, 56:777-793
9. Samuels et al. (2003) Applied Optics, 42(30):6205-6209.
10. Rai et al. (2003) Applied Optics, 42(12):2094-2101.
11. Rai et al. (2003) Applied Optics, 42(12):2078-2084.
12. Portnov et al. (2003) Applied Optics, 42(15):2835-2842.
13. DeLucia et al. (2005) IEEE Sensors Journal, 5(4):681-689.
14. Harmon et al. (2005) Discrimination and identification of plastic landmine casings by single-shot broadband LIBS. in Detection and Remediation Technologies for Mines and Minelike Targets. SPIE.
15. Harmon et al. (2006) Man-Portable LIBS for landmine detection. in Detection and Remediation Technologies for Mines and Minelike Targets. SPIE.
16. Brown et al. (2006) Remote femtosecond laser induced breakdown spectroscopy (LIBS) in a standoff detection regime. in Enabling Technologies and Design of Nonlethal Weapons. SPIE.
17. Lopez-Moreno et al. (2006) Journal of Analytical Atomic Spectroscopy, 21:55-60.
18. Lemire et al. (1993) Analytical Chemistry, 65:529-533.
19. Simeonsson et al. (1994) Analytical Chemistry, 66:2272-2278.
20. Wu et al. (1996) Applied Optics, 35(21):3998-4003.
21. Eckhardt et al. (1962) Physical Review Letters, 9(11):455-457.
22. Maier et al. (1969) Physical Review, 177(2):580-599.
23. Hanna et al. (1986) IEEE Jour of Quantum Electronics, QE-22(2):332-336.
24. Owrutsky, and Baronavski, (1999) Journal of Chemical Physics, 110(23):11206-11213.
25. Farmanara et al. (2000) Chemical Physics Letters, 320:697-702.
26. Zhong et al. (2003) Chemical Physics Letters, 370:609-615.
27. Chen et al. (2005) Journal of Physical Chemistry A, 109:6805-6817.
28. Li et al. (2003) Journal of Chemical Physics, 118(14):6244-6249.

Any patents or publications mentioned in this specification are indicative of the levels of those skilled in the art to which the invention pertains. These patents and publications are incorporated by reference herein to the same extent as if each individual publication was incorporated by reference specifically and individually.

One skilled in the art will appreciate readily that the present invention is well adapted to carry out the objects and obtain the ends and advantages mentioned, as well as those objects, ends and advantages inherent herein. Changes therein and other uses which are encompassed within the spirit of the invention as defined by the scope of the claims will occur to those skilled in the art.

What is claimed is:

1. A method for detecting the presence of a vapor-phase analyte at a distance, comprising:
a) selecting a wavelength absorbed by an analyte of interest;
b) generating a laser pulse of the selected ultraviolet wavelength from a laser source;
c) stimulating vapor-phase molecules of the analyte from a ground state to an excited state within a cylindrical volume via the laser pulse at a defined distance from the laser source; and
d) detecting coherent backscattered amplified spontaneous emission from the excited state molecules within the cylindrical volume thereby detecting the presence of the vapor-phase analyte.

2. The method of claim 1, further comprising:
stimulating a photoproduct of the excited state molecules within the cyclindrical volume with another laser pulse t wavelength after step (c).

3. The method of claim 2, wherein another laser pulse has a different wavelength.

4. The method of claim 1, further comprising:
ablating or thermally desorbing the analyte from a solid surface prior to step (a).

5. The method of claim 1, further comprising:
creating a spectral fingerprint from the detected backscattered amplified spontaneous emission.

6. The method of claim 1, wherein the selected wavelength is an ultraviolet wavelength.

7. The method of claim 1, wherein the selected wavelength is a spontaneously generated harmonic ultraviolet wavelength.

8. The method of claim 7, wherein the ultraviolet wavelength is generated from within a spectral range of about 213 nm to about 1200 nm.

9. The method of claim 1, wherein a detection distance is about 0.01 km to about 1 km.

10. The method of claim 1, wherein the laser pulse has a pulse width of about 150 fs to about 8 ns.

11. The method of claim 1, wherein a lower detection limit of the vapor-phase analyte is about 1 ppm.

12. The method of claim 1, wherein the analyte is a combustible material, a volatile solvent, a flammable solvent, a taggant, a stimulant, a gas, a gas mixture, or a solid.

13. The method of claim 12, wherein the combustible material is a TATP decomposition product, a nitro-aromatic compound, a nitroamine, or other nitro-containing compounds.

14. The method of claim 1, wherein the stimulated molecule is a photoproduct of the vapor-phase analyte.

15. The method of claim 1, wherein detection of backscattered amplified spontaneous emission is in real time.

16. A method for real-time stand-off detection of an energetic material, comprising:
(a) temporally focusing a high fluence ultraviolet laser pulse on a site of interest at a stand-off distance from a laser source;
(b) stimulating vapor-phase molecules associated with the energetic material to an excited state within a cylindrical volume at the site of interest via the laser pulse;
(c) detecting coherent backscattered amplified spontaneous emission from the excited state molecules within the cylindrical volume; and
(d) identifying the vapor-phase molecule from the backscattered amplified spontaneous emission upon the detection thereof, thereby detecting the energetic material at a stand-off in real-time.

17. The method of claim 16, further comprising:
stimulating a photoproduct of the excited state molecules within the cyclindrical volume with another high fluence ultraviolet laser pulse after step (b).

18. The method of claim 17, wherein another laser pulse has a different wavelength.

19. The method of claim 18, wherein the laser pulse has a wavelength or a harmonic wavelength generated from within a spectral range of about 213 nm to about 1200 nm.

20. The method of claim 16, wherein the stand-off distance is about 0.01 km to about 1 km.

21. The method of claim 16, wherein the temporally focused laser pulse has a pulse width of about 150 fs to about 8 ns.

22. The method of claim 16, wherein a lower detection limit of the vapor-phase molecules is about 1 ppm.

23. The method of claim 16, wherein the energetic material is a TATP decomposition product, a nitro-aromatic compound, a nitroamine, or other nitro-containing compound.

24. The method of claim 23, wherein the energetic material comprises an improvised explosive device.

25. The method of claim 16, wherein the stimulated molecule is a photoproduct of the vapor-phase molecule.
